(19) United States
(12) Patent Application Publication
(10) Pub. No.: US 2007/0195870 A1
(43) Pub. Date: Aug. 23, 2007

(54) Wireless mesh data acquisition network

(76) Inventor: James E. Lewis, Hillsboro, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/599,008

(22) Filed: Nov. 13, 2006

Related U.S. Application Data
(60) Provisional application No. 60/736,940, filed on Nov. 14, 2005.

(51) Int. Cl. H04L 5/16

(52) U.S. Cl. 375/219

(57) ABSTRACT

A wireless, mesh data acquisition network utilizes a communication process and provides fault tolerant communication between large numbers of remotely located transducers and devices.

### CROSS-REFERENCE TO RELATED APPLICATIONS

This application claims the benefit of U.S. Provisional App. No. 60/736,940, filed Nov. 14, 2005.

### BACKGROUND OF THE INVENTION

The present invention relates to a data acquisition system and, more particularly, to a data acquisition system comprising a self-organizing, wireless mesh network of remotely located transducers.

Facility management objectives include monitoring individual circuits to avoid overloading, cost saving through load curtailment or reduction during periods of high energy demand, monitoring energy retrofit effectiveness, monitoring environmental quality, and cost allocation. For example, facility occupants are commonly charged for their energy consumption on the basis of their proportionate occupancy. However, tenants with occupancies characterized by lower energy density (energy consumption/square foot) will subsidize the energy usage of tenants with occupancies characterized by higher energy density. This is exacerbated when the building provides central services, such as air conditioning and there are wide variations in occupancy schedules, for example buildings that include both retail space and office space. Moreover, energy rate structures for commercial facilities are complex making a suitable occupancy based rate difficult to establish. Commercial energy rate structures commonly include a consumption charge for energy usage that may be seasonally variable; a demand charge for power consumed during short time intervals, for example, a 15 minute interval; a power factor charge for transmission inefficiencies commonly introduced by pulse modulated power supplies; and other charges and taxes that are sensitive to rates of energy usage, such as load curtailment penalties. When energy usage is billed to tenants on the basis of occupancy, the owner may collect an excessive or an insufficient amount to pay for the energy usage, particularly when energy rates are volatile, occupancy rates are low and a tenant's rate must be established periodically, for example, at the beginning of a lease.

To ensure that the facility operator recovers the cost of energy consumed by the facility's occupants, encourage efficient energy use, and to enable energy cost allocation among tenants, facility managers have adopted sub-metering. Buildings and other facilities typically include a primary metering system that measures the consumption of electricity, gas or other energy for the entire building or facility so that a utility can charge the owner or operator of the facility for the energy usage by the facility. Sub-metering comprises installing meters and other sensors to monitor the consumption of electricity, gas, water, air and steam in individual branch circuits so that the usage can be allocated to individual energy consumers within the facility. A number of manufacturers produce electric meters that are designed for sub-metering and a flow meter installed a branch circuit leading to an individual consumer can be used to measure the consumer's consumption of a gas, liquid or steam. Likewise a BTU meter, combining a flow meter and a temperature sensor, may be used to measure energy usage arising from the consumption of chilled or hot water in a branch circuit, enabling billing a particular consumer for the water consumed and the energy required to chill or heat the water.

Similarly, the combination of new materials and energy conserving ventilation systems has made air quality in individual spaces within a building or facility a matter of concern for facility operators. Pollutants that may be monitored include carbon dioxide, carbon monoxide, formaldehyde, water vapor and radon. Temperature, humidity, gas and particulate sensors may be installed throughout the facility including locations, such as garages and ventilating ducts, to monitor environmental conditions.

Energy management, air quality monitoring and building automation systems are typified by multiple remotely located meters, sensors and other transducers that are connected by a data acquisition network to a central data processing facility. While a network of remote sensing devices enables more effective monitoring and can significantly reduce the cost and risk of operating a facility, the cost of such networks is not insignificant. In addition to the cost of the meters and other sensors to measure conditions at a number of locations and a data processing facility to utilize the data from the transducers, the cost of connecting the network of meters and sensors to communicate with the data processing facility can be significant.

The cost of installing a wired network is particularly significant in existing structures where it is commonly necessary to open walls or fish wires through walls containing plumbing and electrical wiring and to drill holes in floors and roofs to connect remotely located transducers to a central data processing facility. However, the cost of installing a wired network can be also high for new construction. In addition, a wired network is not easily adaptable to change because adding or moving a device requires installing a cable from some point in the network to the new device location.

Many of the problems and costs of installing a data acquisition network for remote sensors can be overcome or reduced by utilizing a wireless communication network. Each node of the wireless network includes a wireless transceiver that can communicate with another network node, typically, by radio frequency signals. Wireless networks avoid much of the installation cost of wired networks and provide more flexibility in relocating and adding nodes to the network. However, many wireless networks used with data processing systems are access point centric with all nodes communicating directly with a network access point. If all the nodes of the network must communicate directly with an access point, all nodes must be within communication range of the access point. It may not be possible to arrange all of the nodes within communication range of the access point because of the remoteness of the locations of the sensors, the limited geographical extent of the network, and interference resulting from the building's structure or operating equipment. Further, since all nodes communicate directly with the access point, bandwidth limitations impose severe limits on the number of nodes that may be included in the network. Moreover, the transceivers commonly used with wireless data processing networks are typically capable of transmitting data at rates far in excess of the output of many low cost meters and sensors. Also the increased cost of the wireless transceivers for a large number of widely scattered meters and sensors will substantially offset any savings from reduced installation cost.

Alternatives to access point centric networks are mesh networks utilizing either link state routing or source path routing for inter-nodal communication. Each node of a network utilizing link state routing generally maintains a table that specifies an optimal path to each network destination. Generally, the optimal routing may be based on many factors including, for example, link quality, signal strength, latency, link stability, and load balancing. When a node in a network utilizing link state routing transmits a message to a destination node, the sender fetches an entry from its routing table specifying which neighbor of the sender should relay the message. The address of the neighbor is inserted in the message header and the message is broadcast. Although all neighbors receive the message, only the neighbor identified in the message header responds to the message. The recipient of the message then obtains the address of one of its neighbors from the recipient's routing table and broadcasts the message again. The process is repeated until the message reaches the ultimate destination. Source path routing is similar to link state routing except that the originating node generally inserts the identities of all nodes that will relay the message into the message header. If a receiving node is not the last node included in the list in the header, it relays the message to the next node on the list. Also, source path routing may use a route list provided by a route controlling node. Both link state routing and source path routing require that each node in the network keep an updated list of neighboring nodes and that each node broadcast any changes in its routing list to neighboring nodes. These broadcasts consume power and network bandwidth and errors in the transmission of information about neighboring nodes can cause network failures.

What is desired, therefore, is a wireless network for connecting a plurality of remotely located transducers which is easy to install and maintain and which is tolerant of failures of individual nodes.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a block diagram of an exemplary wireless mesh data acquisition network.

FIG. 2 is a block diagram of an exemplary data acquisition server.

FIG. 3 is a block diagram of an exemplary meter arranged to communicate according to the MODBUS serial communication protocol.

FIG. 4 is a block diagram of an exemplary transceiver useful in a wireless mesh data acquisition network.

FIG. 5 is a flow diagram of an exemplary sender-receiver transmission in a wireless mesh data acquisition network.

FIG. 6 is a schematic diagram of a sender-receiver query frame.

FIG. 7 is a flow diagram of an exemplary route table update.

### DETAILED DESCRIPTION OF PREFERRED EMBODIMENT

Networks of remotely located meters, sensors and other transducers are the foundation of building automation and energy management systems. While these systems are important to reducing, apportioning and controlling the cost of operating a building or facility, the cost savings are limited and are typically offset, at least to some extent, by the cost of acquiring, installing, and operating the network of sensors. The cost of installing wired networks of remotely located sensors is a significant portion of the cost of acquiring and operating a building automation or energy management system and that a significant part of the installation cost could be eliminated by wirelessly communicating with the network of sensors. However, the cost savings would not be realized if the system required expensive transducers incorporating proprietary communication protocols, expensive communication devices with excessive data rates, or if system complexity and inflexibility resulted in costly or difficult installation and maintenance. Moreover, wireless communications are often difficult in buildings and spaces that include metallic structures and operating machinery and that, to be accepted, the network communication would need to be robust and fault tolerant.

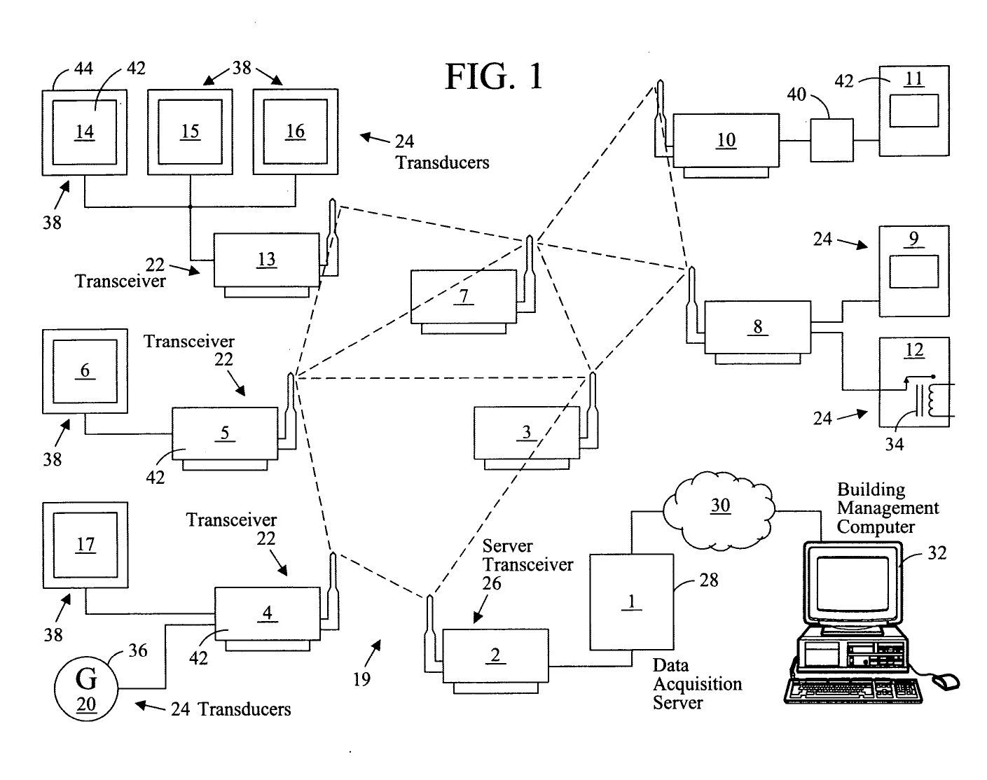

Referring in detail to the drawings where similar parts of a mesh network of transducers are identified by like reference numerals and referring, in particular, to FIG. 1, the wireless mesh data acquisition system 19 comprises a plurality of meters, sensors and other transducers 24 each of which is connected to or incorporates a transceiver 22. Each transceiver 22 is arranged to communicate wirelessly with at least one, and preferably more than one, other transceiver of the system enabling a message to be relayed from one network device to another from the originator to the ultimate recipient. However, a transceiver typically is not able to communicate with all other transceivers as a result of the distances separating the various devices or interference resulting from the presence of structures or emissions from operating machinery. At least one, and preferably more than one, of the transceivers 22 is arranged to communicate with a data acquisition transceiver 26 that is communicatively connected to a data acquisition server 28.

At specified intervals, upon the occurrence of an event or at other times, the data acquisition server 28 establishes communication with the network's transducers and collects the data output by them. The transducer data is processed and stored by the data acquisition server 28 which may include one or more application programs that provide an interface for managing the facility and the network, including utilizing the transducer data to provide graphical presentations useful to the facility management or operating instructions for automated building equipment. On the other hand, the data acquisition sensor 28 may collect the transducer data and periodically upload the data, by way of a communication network, such as a local area network (LAN) or the Internet 30, to a building management computer 32 that includes the building and energy management application programs.

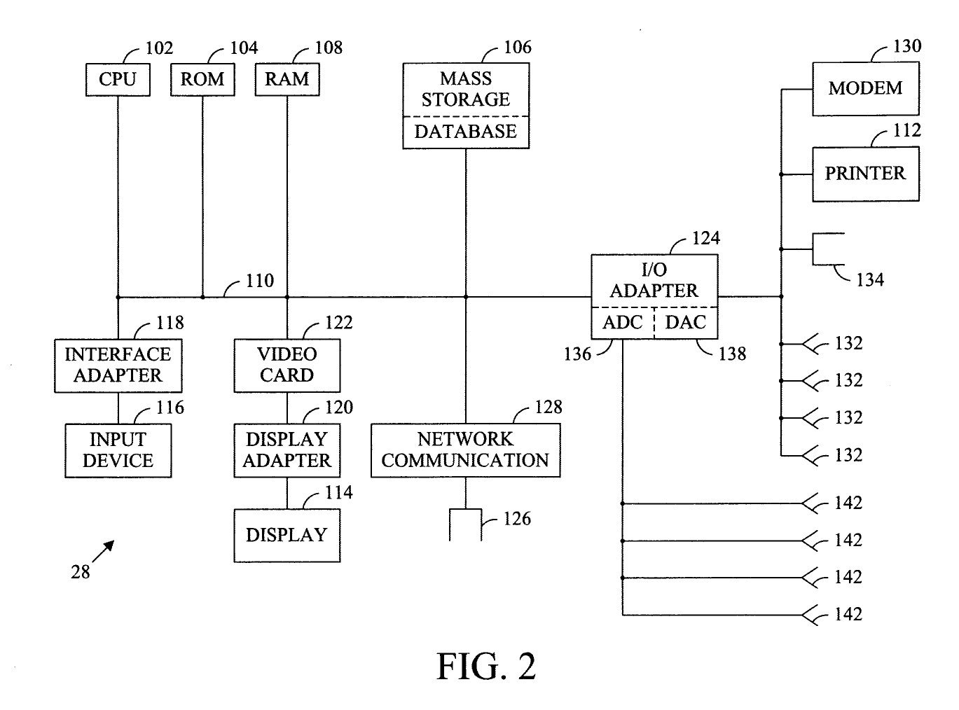

Referring to FIG. 2, while the data acquisition server 28 can take many forms, it typically comprises, generally, a microprocessor-based, central processing unit (CPU) 102 that fetches data and instructions, processes the data according to the instructions, and stores the results or transmits the results to an output device or another data processing device, such as the building management computer 32. Typically, basic operating instructions used by the CPU 102 are stored in nonvolatile memory or storage, such as a flash memory or read only memory (ROM) 104. Instructions and data used by application programs are typically stored in a nonvolatile mass storage or memory 106, such as a disk storage unit or a flash memory. The mass storage 106 comprises, in part, a database 118 comprising device parameters defining the various devices making up the network and a routing table comprising communication routes, ordered lists of devices, through the network. The data and instructions may be transferred from the mass storage 106 to a random access memory (RAM) 108 and fetched from RAM by the CPU 102 during execution. Data and instructions are typically transferred between the CPU, ROM, RAM, and mass storage over a system bus 110.

The data acquisition server 28 may also include a plurality of attached devices or peripherals, including a printer 112, a display 114, and one or more user input devices 116, such as a keyboard, mouse, or touch screen. Under the control of the CPU 102, data is transmitted to and received from each of the attached devices over a communication channel connected to the system bus 110. Typically, each device is attached to the system bus by way of an adapter, such as the interface adapter 118 providing an interface between the input device 116 and the system bus. Likewise, a display adapter 120 provides the interface between the display 114 and a video card 122 that processes video data under the control of the CPU. The printer 112 and similar peripheral devices are typically connected to the system bus 110 by one or more input-output (I/O) adapters 124. On the other hand, the data acquisition server 28 may rely on another data processing system, such as the building management computer 32, for an input device, a display and other peripheral devices. The data acquisition server 28 also commonly includes facilities for communicating with other data processing devices. These facilities may include a network connection 126 and communication device 128 enabling communication over a wide area network (WAN) or a local area network (LAN) and one or more modems 130 for communication over a telephone system or another communications link, including the Internet 30, to another remotely located data processing device.

Building automation and energy management systems commonly rely on meters, sensors and other transducers having either a pulse output, an analog output, or a digital serial output, such as one conforming to the MODBUS protocol. The system may likewise use a peer-to-peer system, or a master-to-slave system. The electrical “pulse” produced by the closure of the contacts of a switch or relay 34 is commonly used in sensors to signal the state of a device or system. By way of examples, thermostats and pressure switches produce a pulse output when the temperature or pressure has reached a specific value causing closure of a set of electrical contacts. Many meters also utilize pulses to ascertain the measured parameter. Typically, these meters include a mechanism, such as a turbine or a tachometer that is arranged to actuate a switch, relay or solid state device as the mechanism moves in response to changes in the value of the measured parameter. The magnitude or rate of change of the measured parameter can be determined by totaling the number of pulses output by the meter during a time interval and multiplying the number or frequency of pulses by a constant representing the per pulse change in the value of the measured parameter. Typical pulse output meters include utility supplied power, water, and gas meters 36. The data acquisition server 28 may include pulse input ports 132 for connecting of one or more pulse output meters and sensors directly to the server.

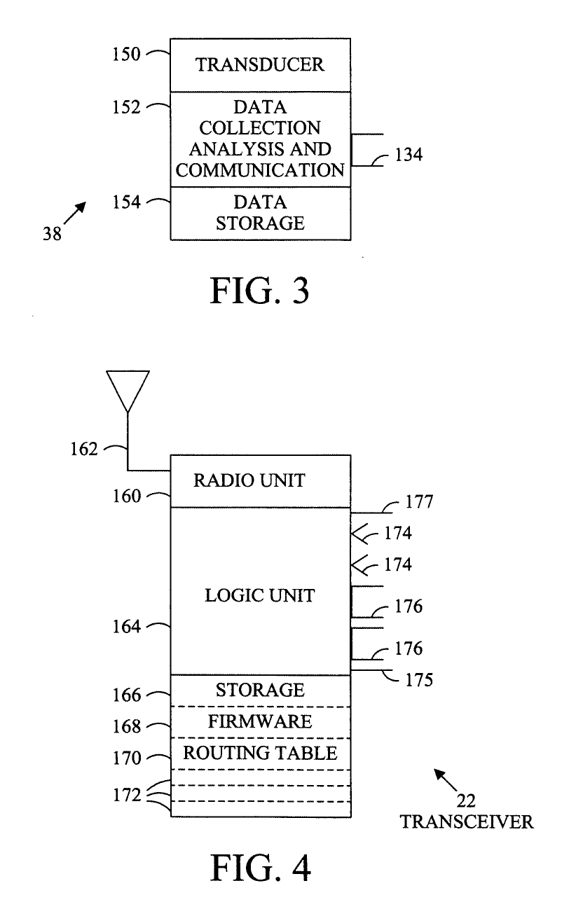

Many of the meters and other transducers used for building and facility management are equipped for digital serial communication according to the MODUBUS APPLICATION PROTOCOL SPECIFICIATION, V1.1a, MODBUS-IDA, Jun. 4, 2004 or MODBUS OVER SERIAL LINES, v 1.0, MODBUS-IDA, Dec. 2, 2002, incorporated herein by reference. The MODBUS protocol provides an application layer messaging protocol enabling client/server communication between devices that are connected to different types of buses and networks. Referring to FIG. 3, a typical MODBUS device 38, a meter utilizing the MODBUS protocol, includes a transducer 150 for ascertaining a measured parameter, a data collection, analysis and communication system 152 and data storage 154. In addition to providing basic information about the consumption of the measured parameter, these devices often provide related information, such as the power factor and harmonic distortion, which may be calculated by the data collection, analysis and communication system 152 from the data that is collected and stored. The data collection and analysis system 152 commonly comprises a microprocessor based CPU that collects data output by the transducer 150, performs local analysis, and manages serial communication with consumers of the data. Devices utilizing the MODBUS serial communication protocol commonly communicate with other devices over an RS-485 serial connection and the data acquisition server 28 includes one or more RS-485C compatible serial interfaces 134 defining the pinouts, cabling, signal levels and transmission rates for a RS-485 serial connection of one or more MODBUS devices to the data acquisition server 28. Devices utilizing the MODBUS serial communication protocol may also be connected to the Internet or to an Ethernet network and communicate through a TCP/IP stack with other data processing devices.

The I/O adapter 124 of the data acquisition server 28 commonly provides one or more analog-to-digital converters (ADC) 136 to convert analog signals to digital signals suitable for processing by the CPU 102. Analog signals may be received from analog meters and transducers that can be wired directly to one or more analog input ports 142 of the data acquisition server 28. The I/O adapter may also include one or more digital-to-analog converters (DAC) 138 to convert the digital signals output by the CPU to analog signals that may be required by peripheral equipment attached to the data acquisition server.

Network communications are accomplished by the data acquisition server 28, the MODBUS devices and a plurality of wireless transceivers 22. The data acquisition server 28 and each meter, sensor, or other transducer, not wired directly to the data acquisition server, is connected to a transceiver 22, although a transceiver, for example transceiver 48, is not necessarily connected to a transducer. Communications within the network are performed by relaying messages or queries from transceiver to transceiver and a transceiver might be used to bridge portions of the network even though that transceiver is not located near a transducer. Referring to FIG. 4, a transceiver 22 typically comprises a radio unit 160 having an antenna 162, a logic unit 164 and data storage 166. The frequency of radio transmissions is commonly 900 MHz, in the unlicensed Instrument, Scientific and Medical (ISM) band, but can be any convenient frequency. The power of transmitters operating in the ISM band have a typical range of 300 to 500 feet, but may be extended if desired. However, the range can be significantly reduced by a number of environmental factors such as the location of the transceivers relative to significant structures, such as components of the building's framework, other metal structures within building spaces or operating machinery. Radio frequency signals are typically used for the communications within the wireless mesh data acquisition network because the signals are omnidirectional and line of sight is not required between transceivers. However, other signaling mechanisms such as infra-red light transmissions could be used.

Generally, the data storage 166 is occupied by firmware 168 for controlling the logic unit and a routing table 170 containing ordered listings of devices making up communication paths between the data acquisition server 28, neighboring transceivers and the transducers that are connected to a transceiver. In addition, the data storage 166 includes one or more registers 172 for storing the readings from a pulse output meter or sensor that is connected to the transceiver. Although a pulse output device may be identified as an element of the network, the device is considered to be passive and the data acquisition server 28 physically addresses the register of the transceiver's data storage containing the output of a specific pulse output meter or sensor. A transceiver 22 also includes ports for connecting pulse output meters and sensors 174 and RS-485C compatible connections 175 for connecting the RS-485 interface of MODBUS devices 38 outputting serial communications according to the MODBUS protocol. An analog sensor or meter may be connected to a transceiver 22 through an analog-to-digital converter (ADC) 40 that outputs MODUS serial communications to the RS-485 ports 177 of a transceiver. The ADC may likewise be included within the transceiver 22.

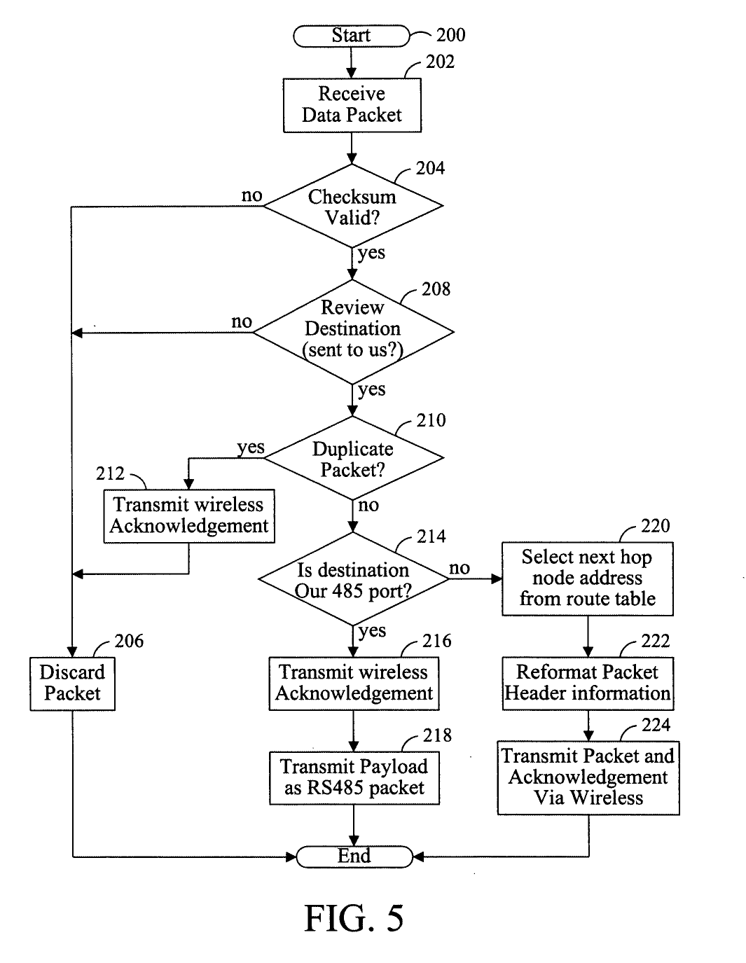

MODBUS devices can communicate by either broadcasting a message to other devices or with a sender-recipient technique in which one device can initiate transactions or queries of another device. When the sender-recipient technique is utilized, the receiving device acknowledges the receipt of the message and responds to the query by supplying the data or taking the action requested by the sender in the query. In the mesh data acquisition network 20, data is acquired from the remote transducers when the data acquisition server 28 transmits a query addressed to a transducer. Referring to FIG. 5, a query is initiated 200 by a MODBUS compliant device, for example the data acquisition server 28. One or more transceivers in the network simultaneously receive a data packet 202 broadcast from another transceiver. Initially each receiving transceiver verifies 204 that the data packet is valid by checking the validity of the packet's checksum. If the checksum is not valid, then the packet is discarded 206. In many cases, a transmitting transceiver can broadcast a packet that is simultaneously received by many different transceivers. However, in most cases, only one transceiver is the intended destination. If the checksum is valid, then the receiving transceiver checks the packet to determine if the receiving transceiver is the intended destination 208 for the packet. If the recipient transceiver is not the intended destination, then the packet is discarded 206. If the receiving transceiver is the intended destination then the device determines if the received packet is a duplicate packet 210. In the event that the receiving transceiver has received the same valid packet multiple times, it may transmit an acknowledgement 212 so that the transmitting transceiver knows that the packet has been received by the desired receiving transceiver. In this manner, the transmitting transceiver may cease retransmitting the packet, and thus free up available wireless bandwidth. In addition, if the receiving transceiver receives the same packet multiple times, then the receiving transceiver may discard the packet since it has already been previously properly received. This reduces the processing requirements of the transceiver by discarding some duplicate packets.

The receiving transceiver checks to determine if it was the final destination device and/or one of the desired MODBUS devices are connected to the transceiver for the particular packet. In the case that the receiving transceiver is the final destination from which the requested data is available, the receiving transceiver transmits an acknowledgement 216 to the transmitting transceiver. In this manner, the transmitting transceiver is notified that the packet has been properly received and can therefore stop retransmitting the packet or otherwise re-routing the packet to other devices. After obtaining the desired payload data to return to the originating querying MODBUS compliant device, the receiving transceiver transmits the data 218 to the originating MODBUS compliant device.

The receiving transceiver may be the destination device for the packet, but does not have the desired data, which is the case when the receiving transceiver is an intermediate transceiver within a network. The transceiver which does not have the data selects another transceiver to forward the packet to. The transceiver checks its route table for the desired destination device, and selects the next transceiver to send the packet to 220. The packet header is reformatted 222 to include the new destination device transceiver for the packet header. In many cases, the packet header will contain information identifying the entire path through the network that the packet has passed, so that routing information may be extracted. The transmitting transceiver then transmits 224 the reformatted packet with the new destination transceiver and also provides an acknowledgement to the previous transmitting transceiver that the packet has been received. In this manner, the receiving transceiver does not falsely respond to the transmitting transceiver in the event it isn't the desired destination or the packet is not valid, and properly acknowledges to the transmitting transceiver in the event that the destination transceiver has the desired data or otherwise has sufficient information to retransmit the packet to its final destination. In the event that the receiving transceiver lacks sufficient data to transmit the data to the final destination device, it does not acknowledge the transmitting transceiver, which will at some point, attempt to reroute the data to the destination device via another path.

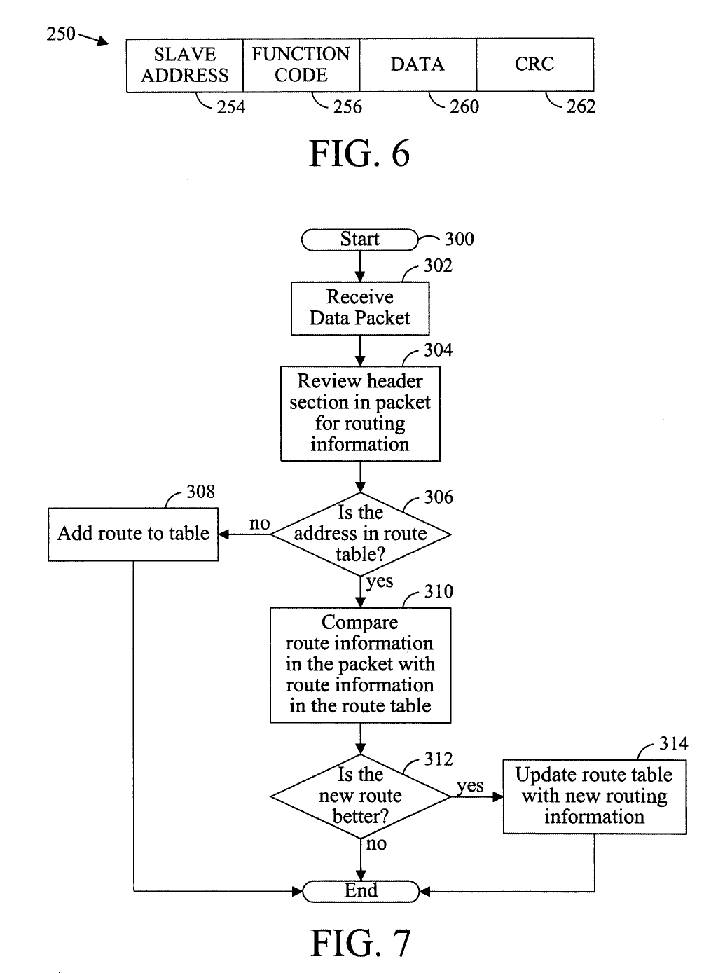

The data acquisition server typically queries the transducers and collects transducer output upon the occurrence of an event or the expiration of an interval specified for collecting data from the networks meters and sensors. The data acquisition server 28 selects the network address of the meter, other transducer or device to be queried and composes a query specifying the information sought from or the action to be taken by the recipient of the query. Referring to FIG. 6, the MODBUS Remote Terminal Unit query frame 250 begins and ends with a specific sequence of characters so that receivers can detect the frame. The query frame 250 includes the slave address 254 and the function code 256. The MODBUS frame itself does not include information about the mesh routing activity performed by the transceiver 22. In the mesh data acquisition network each transceiver, meter, transducer or other device that can receive a query is assigned a network identification 42 which purposes of reference are indicated by underlined decimal numbers in FIG. 1 and enclosed in brackets herein. The network identification may be the slave address 254. For example, in the exemplary network 20, the MODBUS meter, device 44, is assigned the network identification [14] and the gas meter 36 is assigned the network identification [20]. The MODBUS protocol permits network devices to be identified with the digital equivalents of the decimal numbers [1-247]. The device identification [0] is reserved for broadcast transmissions. In addition, the query 250 includes a function, if any, to be performed by the addressee, a data payload 260, and a cyclic redundancy check (CRC) 262 that is used by receiver of the query to determine if query, as received, included an error.

The query is transmitted to a data acquisition transceiver 26, a transceiver that may be physically separate from or incorporated into the data acquisition server and serves as the wireless communication interface for the data acquisition server 28. A link state routed network does not include an explicit routing from the server transducer 26, through each device in the route through the network, to the desired transceiver 22. This network configuration, the originating device only needs to construct a MODBUS Remote Terminal Unit query frame that includes the slave address without any particular knowledge of the configuration of the network. In this manner the MODBUS devices can operate in a normal manner while the routing appears to occur in a transparent manner.

Referring to FIG. 7, the data acquisition server 28, other MODBUS device, or transceiver, routes a packet within the network based upon a routing table. The device 300 receives a data packet 302 that contains routing information. Routing information may be contained within the query requests or may be contained within control packets transmitted within the network to ascertain appropriate routing information. In most cases the header information is where the routing information is included. The transceiver examines the header section from the packet for routing information 304. If the address of a MODBUS device or another transceiver (which may have a MODBUS address) is not in the existing route table of the receiving transceiver then the route from the MODBUS device or transceiver to the receiving transceiver is added 308 to the routing table of the receiving transceiver. In this manner, the routing table of the transceiver can be updated as new devices are identified. Accordingly, when a packet is received with a destination identification that is not in the routing table, then the receiving device adds it to its routing table.

If the address of a MODBUS device or other transceiver is in the existing route table of the receiving transceiver then the route information in the packet is compared against the route information in the route table 310. A decision is made, on any suitable criteria, to determine if the new route is better than the existing route in the route table. If the existing route is not better than the existing route in the route table then the route table is not modified. The data packet may be forwarded onto other transceivers with the routing information of where the packet has been received and transmitted. If the new route is better than the existing route table then the route table is updated with the new route information 314. The transceiver may forward the packet onto another hop in the network.

It may be observed that each node in the mesh network has a unique routing table that is the node's view of all the other nodes in the network. The information contained in this routing table may include the next node to send the packet to in the case that there is not a direct path to reach the final desired final destination. In this manner, the routing table will know the next destination to transmit the packet to reach the destination. The system may track the number of hops to reach the final destination, and take this into account when determining if a new potential path to the destination is better than an existing path in the route table. The system may further keep track of the local quality of the link between itself and all other devices in direct contact. In some cases, there will be few signal interruptions and the other device may be relatively close, resulting in a good local quality link. In other cases, there will be signal interruptions and the other device may be relatively far apart, resulting in a poor local quality link. The local link quality may be used when determining if a new potential path to the destination is better than an existing path in the route table. The system may further keep track of the remote quality of the link between itself and all other devices not in direct contact. The system may omit the direct link between itself and the next device in the remote quality link, if desired. In some cases, there will be few signal interruptions and the other devices may be sufficiently close to one another, resulting in a good remote quality link. In other cases, there will be signal interruptions and the other devices may be relatively far apart, resulting in a poor remote quality link. The remote link quality may be used when determining if a new potential path to the destination is better than an existing path in the route table. One or more of these criteria may be used alone or in combination to determine the best path for the route table.

When the new device receives the query from the data acquisition server 526, it updates its network identity 530 and its routing table 532, and transmits its device parameters to the data acquisition server 534. Although the data acquisition server 28 may be engaged in other tasks, it waits 562 for receipt of a reply 562 to take further steps in the self-discovery process. The data acquisition server 28 updates the network description with the new device parameters 566 and, if the device parameters indicate that the device is a transceiver 568, transmits a query to the new device directing it to perform route discovery 570 to identify possible communication routes to the data acquisition server. The data acquisition server updates its routing table with any additional routes reported in the route discovery queries initiated by the new device 572 and the device self-identification process is completed 574 for the data acquisition server. For the newly installed device, the self-identification process is completed 538 upon the completion of any additional route discovery activity 536 undertaken following receipt of the device's network identity. Device self-identification permits a user to replace or install new devices in the data acquisition network by locating the new device within range of and an existing network transceiver 22 and energizing the device, greatly simplifying changing and maintaining the data acquisition system.

The wireless, mesh, data acquisition network utilizes a link-state discovery process and may include a device self-identification process to provide a self-organizing network with fault tolerant communication between a data acquisition server and many remotely located transducers.

The detailed description above sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for transmitting MODBUS data from a first MODBUS device to a second MODBUS device comprising the steps of:
(a) directing a transmission of said data from said first MODBUS device to a first transceiver arranged to relay said data to at least said second MODBUS device based upon link state routing; and
(b) if receipt of said transmission is not acknowledged by said first transceiver, directing a second transmission of said MODBUS data to a second transceiver arranged to relay said data to at least said second device based upon said link state routing.

2. The method for transmitting data from a first device to a second device of claim 1 wherein said first device wirelessly transmits at least one of said transmission and second transmission.

3. The method for transmitting data from a first device to a second device of claim 1 wherein the step of directing a second transmission of said data to a second transceiver if receipt of said transmission is not acknowledged by said first transceiver comprises said first device monitoring a transmission medium for an acknowledgment message, said acknowledgement message to be transmitted to said first device by said first transceiver upon receipt of said transmission.

4. A data acquisition network comprising:
(a) a first device;
(b) a first transceiver arranged to receive a query from a second device and to relay said query to said first device, said first transceiver acknowledging to said second device receipt of a query from said second device;
(c) a second transceiver arranged to receive a query from said first transceiver and to relay said query to said first device, said second transceiver acknowledging to said second device receipt of a query from said first transceiver; and
(d) said first transceiver selecting one of said first transceiver to said second device, and said first transceiver to said second transceiver to said second device as a desired path from said first transceiver to said device based upon a criteria.

5. The data acquisition network of claim 4 wherein a transceiver relaying said query to said first device appends an identification of said transceiver to a data payload in said query.

6. The data acquisition network of claim 4 wherein said query comprises a remote terminal unit data frame according to a MODBUS serial communication protocol.

7. A data acquisition network comprising:
(a) a first device;
(b) a first transceiver arranged to receive a query from a second device and to relay said query to said first device;
(c) a plurality of other transceivers arranged to receive a query from said first transceiver and to relay said query to said first device; and
(d) said first transceiver selecting a path from said first transceiver to said first device based upon comparing a plurality of different paths from said first transceiver to said first device based upon a criteria.

8. The data acquisition network of claim 7 wherein each of said plurality of transceivers includes a unique routing table.

9. The data acquisition network of claim 7 wherein said criteria include the number of transceivers between said first transceiver and said second device.

10. The data acquisition network of claim 7 wherein said criteria includes the quality of the link between transceivers in direct communication with each other.

11. The data acquisition network of claim 7 wherein said criteria for a routing table of said first transceiver includes the quality of the link between transceivers not in direct communication with said first transducer.

12. The data acquisition network of claim 7 wherein said criteria for a routing table of said first transceiver includes the quality of the link between transceivers not in direct communication with said first transducer without including the quality of the direct link between said first transceiver and another said transducer.
